(19) United States
(12) Patent Application Publication
(10) Pub. No.: US 2025/0367890 A1
(43) Pub. Date: Dec. 4, 2025

(54) METHOD OF MANUFACTURING A LIGHTWEIGHT PANEL FOR A VEHICLE

(71) Applicants: HYUNDAI MOTOR COMPANY, Seoul (KR); KIA CORPORATION, Seoul (KR); DAESOL AUSYS CO.,LTD, Incheon (KR)

(72) Inventors: Jung-Jong Chun, Hwaseong-si (KR); Soo-Bok Kim, Hwaseong-si (KR); Keon-Chul Lee, Hwaseong-si (KR); Min-Soo Kim, Hwaseong-si (KR); Chae-Wook Lee, Hwaseong-si (KR); Seung-Hu Cho, Siheung-si (KR); Jae-Kwan Ko, Seoul (KR); Min-Ho Kwon, Seoul (KR); Jae-Kyun Namgung, Incheon (KR)

(73) Assignees: HYUNDAI MOTOR COMPANY, Seoul (KR); KIA CORPORATION, Seoul (KR); DAESOL AUSYS CO.,LTD, Incheon (KR)

(21) Appl. No.: 18/960,765

(22) Filed: Nov. 26, 2024

(30) Foreign Application Priority Data
Jun. 3, 2024 (KR) 10-2024-0072390

(51) Int. Cl. B29C 70/46; B29L 31/30

(52) U.S. Cl. CPC B29C 70/46; B29C 2793/009; B29L 2031/30

(57) ABSTRACT

A method of manufacturing a lightweight panel for a vehicle includes a mat fixing operation of manufacturing a first semi-finished product by fixing a mat to each of upper and lower surfaces of a paper honeycomb in a predetermined thickness and a resin spraying operation of manufacturing a second semi-finished product by applying a resin to each of upper and lower surfaces of the first semi-finished product. The method also includes a thermal molding operation of manufacturing a third semi-finished product by thermally molding the second semi-finished product between a heated upper thermal mold and a heated lower thermal mold, a sheet attaching operation of manufacturing a fourth semi-finished product by attaching a sheet molded on an upper surface of the third semi-finished product, and a trimming operation of cutting an unnecessary area of the fourth semi-finished product.

### CROSS-REFERENCE TO RELATED APPLICATION

This application claims priority to Korean Patent Application No. 10-2024-0072390, filed on Jun. 3, 2024, and which is incorporated herein by reference in its entirety.

### BACKGROUND

### Field of the Disclosure

The present disclosure relates to a method of manufacturing a lightweight panel for a vehicle, which has a lightweight honeycomb structure applied to an interior.

### Description of Related Art

Various types of panels 120 are used in vehicles to partition an internal space of the vehicle or form an exterior of the vehicle.

For example, FIG. 1 shows a luggage board as an example of a panel 120. The luggage board may be used to separate a cabin and a loading space of the vehicle.

A cross section of the panel 120 has a structure as shown in FIG. 2. A honeycomb part 121 is formed by processing a paper honeycomb P, A reinforcing layer 123 is formed on upper and lower surfaces of the honeycomb part 121 by spraying polyurethane after a fiberglass (e.g., a glass fiber) mat is fixed to each of the upper and lower surfaces of the honeycomb part 121. The reinforcing layer 123 is formed by infusing or impregnating the fiberglass mat with the polyurethane. A portion of the polyurethane is infused or impregnated into the honeycomb part 121 to form an infusion or impregnation layer 122.

A paper honeycomb P, which becomes the honeycomb part 121, may include hexagonal pillars, which are continuously formed without any gap using paper, as shown in the enlarged view of FIG. 2. The continuously formed hexagonal pillars may exhibit rigidity. The paper honeycomb P may be lightweight due to being formed of a paper material. In particular, the fiberglass mat (e.g., glass fiber mat) forms the reinforcing layer 123 through the polyurethane on the upper and lower surfaces of the honeycomb part 121, thereby further increasing rigidity.

When the reinforcing layer 123 and the impregnation layer 122 are formed on the honeycomb part 121, a desired shape is manufactured using a thermal mold.

Thereafter, when the panel 120, for example, a luggage board, is mounted on the vehicle, a skin layer 124 is formed by surrounding a lower surface, which is not visible (e.g., from an interior of the vehicle) with non-woven fabric 125 and surrounding a visible upper surface with carpet.

However, the panel 120 in the related art has a problem that an area or portion of a vehicle to which the panel may be applied is unavoidably limited to a luggage board, etc. as the overall thickness of the honeycomb part 121 is constantly formed.

In addition, since the panel 120 is formed only in a constant thickness, an area to which the panel 120 may be applied is unavoidably limited.

In addition, since surfaces, for example, upper and lower surfaces of the panel 120 are formed to be flat, a shape of the panel 120 is simple, and it is difficult to secure a space for additionally mounting other devices.

### SUMMARY

The present disclosure has been invented to solve the above-noted problems and is directed to a method of manufacturing a lightweight panel for a vehicle, whereby the method facilitates manufacturing of the panel.

To achieve these objects, according to the present disclosure, a method of manufacturing a lightweight panel for a vehicle is provided. The method includes fixing a mat to each of upper and lower surfaces of a paper honeycomb having a predetermined thickness during a mat fixing operation thereby manufacturing a first semi-finished product. Additionally, the method includes applying a resin onto each of upper and lower surfaces of the first semi-finished product during a resin spraying operation thereby manufacturing a second semi-finished product. The method also includes molding the second semi-finished product between a heated upper thermal mold and a heated lower thermal mold during a thermal molding operation thereby manufacturing a third semi-finished product. The method also includes attaching a molded sheet to an upper surface of the third semi-finished product during a sheet attaching operation thereby manufacturing a fourth semi-finished product and cutting an unnecessary area from the fourth semi-finished product during a trimming operation.

An inside of the paper honeycomb provided in the mat fixing operation is machined to a predetermined thickness through milling.

The mat in the mat fixing operation is a fiberglass mat.

The paper honeycomb provided in the mat fixing operation is provided in a state of being machined to be larger than a target size and the paper honeycomb is molded to the target size in the thermal molding operation.

The resin spraying operation includes spraying the resin from resin spray nozzles disposed to vertically face each other while moving the first semi-finished product between the resin spray nozzles and applying the resin onto the upper and lower surfaces of the first semi-finished product.

The resin spraying operation includes spraying polyurethane onto the upper and lower surfaces of the first semi-finished product.

The method further includes seating the second semi-finished product on the lower thermal mold during a seating operation.

A guide plate configured to guide the seating of the second semi-finished product is installed on a perimeter of the lower thermal mold.

The seating operation includes bringing a side end of the second semi-finished product into contact with the guide plate when the second semi-finished product is seated.

The sheet attaching operation includes bonding the sheet to an upper surface of the third semi-finished product by seating the third semi-finished product on the lower sheet attachment mold, applying an adhesive onto the upper surface of the seated third semi-finished product, attaching the molded sheet to the upper surface of the third semi-finished product, and moving an upper sheet attachment mold downward.

The trimming operation includes trimming a perimeter of the fourth semi-finished product seated on a jig while a water jet nozzle moves along the perimeter of the fourth semi-finished product.

The method further includes a sheet molding operation of molding a sheet forming a skin of a panel to a predetermined shape.

The sheet molding operation includes molding the sheet to a shape of an upper surface of a sheet mold by heating the sheet whose perimeter is fixed to a sheet fixing frame and moving the sheet mold upward.

The sheet molding operation includes bringing the sheet into contact with the sheet mold by removing air between the sheet and the sheet mold when the upward movement of the sheet mold to the sheet is completed.

The sheet molding operation is performed before the sheet attaching operation.

According to the methods of manufacturing a panel for a vehicle of the present disclosure, since the panel is manufactured using a paper honeycomb that has the repeated hexagonal pillars therein and is made of paper, it is possible to provide a lightweight panel, which is easy to handle when applied to the vehicle and exhibits sufficient rigidity.

In addition, by guiding the semi-finished product to the guide plate when seated on the mold for thermal molding in the manufacturing process, the semi-finished product can be easily seated at the correct location, and movement of the semi-finished product can be prevented.

### BRIEF DESCRIPTION OF THE DRAWINGS

FIG. 1 is a perspective view of a luggage board according to an example of a panel in the related art.

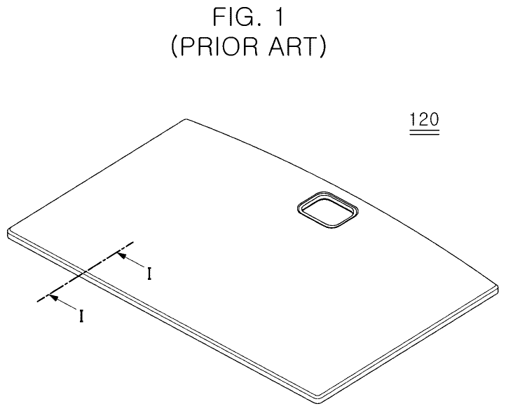

FIG. 2 is a cross-sectional view along line I-I in FIG. 1.

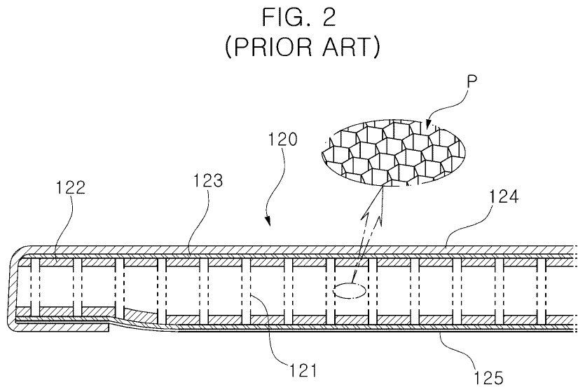

FIG. 3 is a perspective view showing a vehicle to which a roof panel, manufactured by a method of manufacturing a lightweight panel for a vehicle according to the present disclosure, is mounted.

FIG. 4 is a perspective view showing a roof panel, manufactured by a method of manufacturing a lightweight panel for a vehicle according to the present disclosure, detached from a vehicle.

FIG. 5 is a flowchart showing a method of manufacturing a lightweight panel for a vehicle according to the present disclosure.

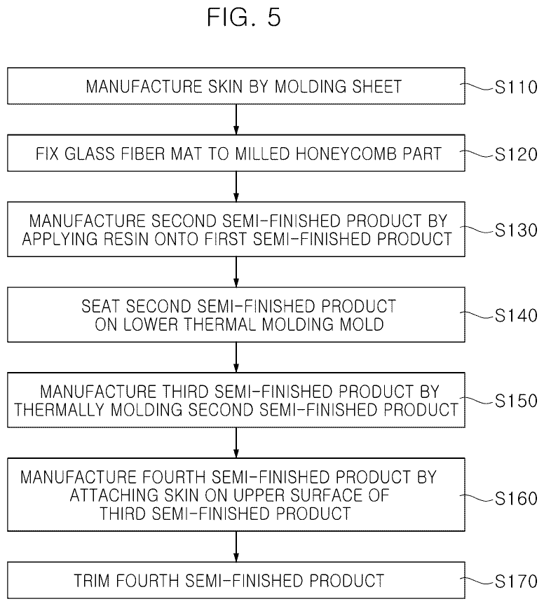

FIG. 6 is a schematic view showing a state in which a sheet mold moves upward to a sheet in a method of manufacturing the lightweight panel for a vehicle according to the present disclosure.

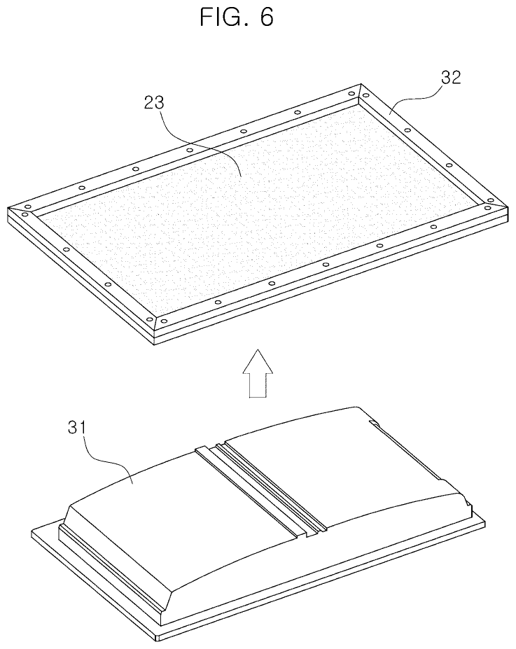

FIG. 7 is a perspective view of a sheet molded by a sheet molding operation in the method of manufacturing the lightweight panel for a vehicle according to the present disclosure.

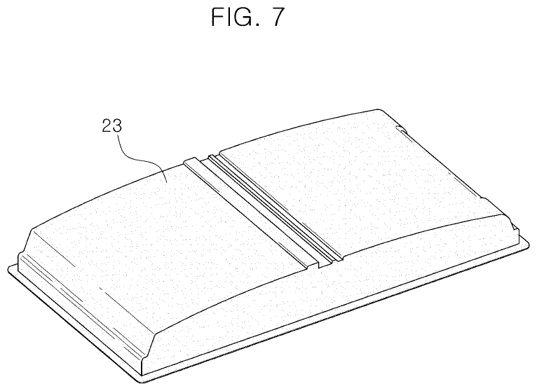

FIG. 8 is a plan view showing a state in which a paper honeycomb is milled in the method of manufacturing the lightweight panel for a vehicle according to the present disclosure.

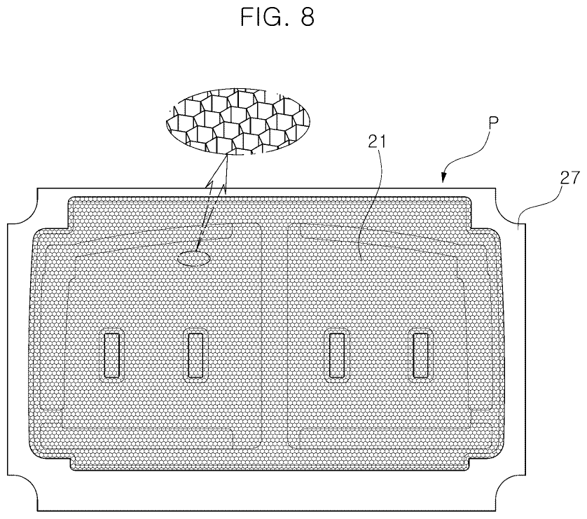

FIG. 9 is a schematic view showing a state in which a resin is sprayed onto a first semi-finished product in the method of manufacturing the lightweight panel for a vehicle according to the present disclosure.

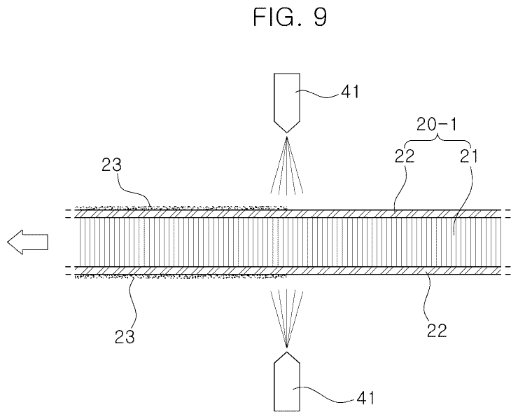

FIG. 10 is a schematic view showing a state in which an upper thermal mold moves downward when a second semi-finished product is seated on a lower thermal mold in the method of manufacturing the lightweight panel for a vehicle according to the present disclosure.

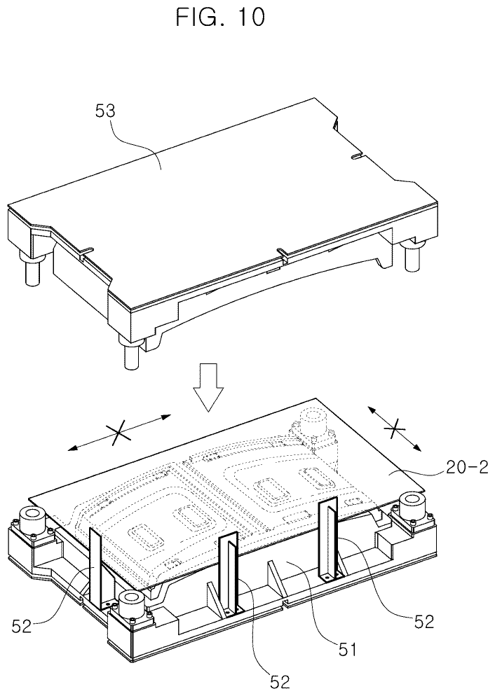

FIG. 11 is a cross-sectional view showing a state in which the second semi-finished product is seated on the lower thermal mold in the method of manufacturing the lightweight panel for a vehicle according to the present disclosure.

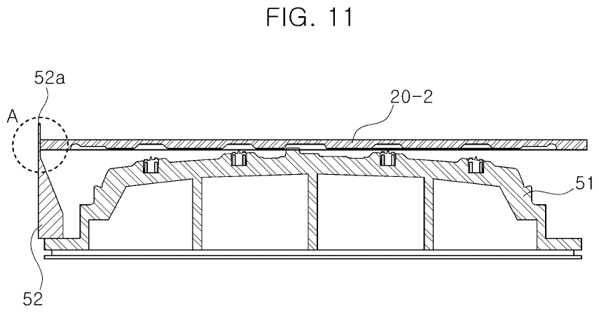

FIG. 12 is a schematic view showing a state in which a molded sheet is attached when a third semi-finished product is seated on a lower sheet attachment mold, and an upper sheet attachment mold moves downward in the method of manufacturing the lightweight panel for a vehicle according to the present disclosure.

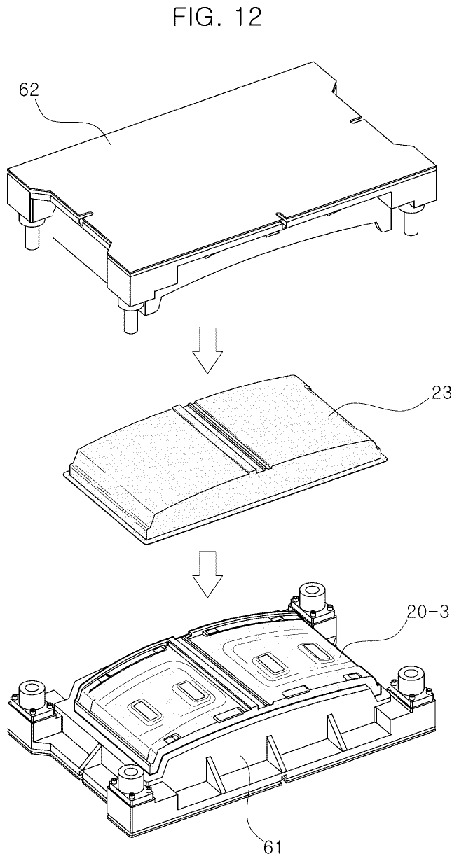

FIG. 13 is a schematic view showing a process of removing scrap using a water jet nozzle in the method of manufacturing the lightweight panel for a vehicle according to the present disclosure.

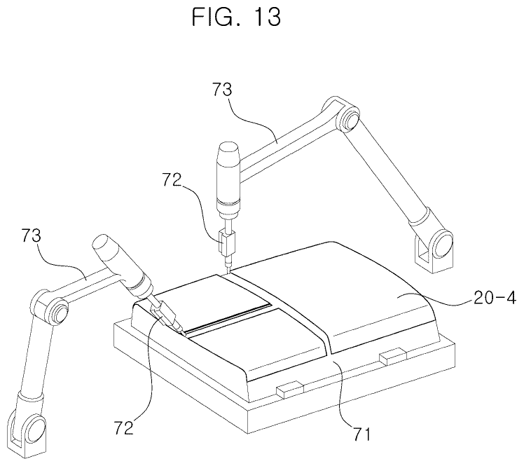

### DESCRIPTION OF SPECIFIC EMBODIMENTS

Hereinafter, a method of manufacturing a lightweight panel for a vehicle according to the present disclosure is described in detail with reference to the accompanying drawings. When a component, device, element, or the like of the present disclosure is described as having a purpose or performing an operation, function, or the like, the component, device, or element or the like should be considered herein as being “configured to” meet that purpose or perform that operation or function.

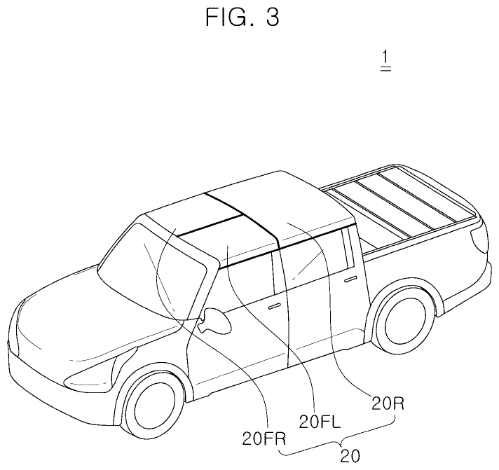

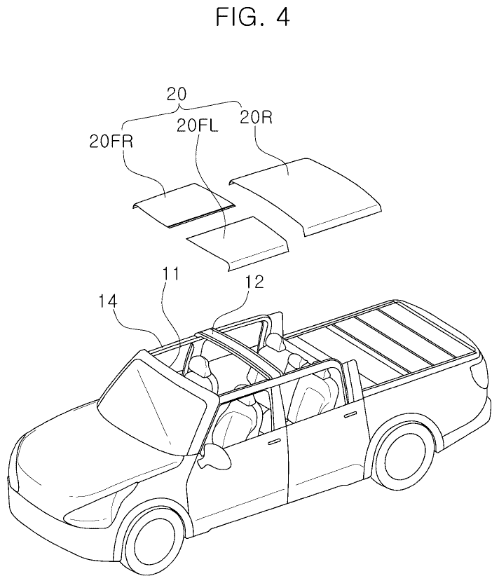

FIGS. 3 and 4 show an example in which a panel, manufactured according to a method of manufacturing a lightweight panel for a vehicle according to the present disclosure, is a roof panel for a vehicle.

A roof panel 20 may be detachably installed on a vehicle 1 to further expand a sense of openness perceived by a passenger of the vehicle in a limited traveling environment. Meanwhile, the panel may be applied not only as the roof panel 20 in a vehicle, but also as exterior panels of a vehicle such as a hood, a tailgate, and a trunk lid.

A front rail 11 and a center rail 12 are formed on a roof of the vehicle 1 and may extend in a width direction of the vehicle 1. A roof side rail 14 is formed on or alongside surfaces of the roof and may extend in a longitudinal direction of the vehicle 1. The roof panel 20 is mounted to the vehicle through the front rail 11, the center rail 12, and the roof side rail 13.

The roof panel 20 is partitioned into a plurality of subpanels 20FL, 20FR, and 20R. The subpanels 20FL, 20FR, and 20R include the first subpanel 20FL that becomes a front left roof panel, a second subpanel 20FR that becomes a front right roof panel, and a third subpanel that becomes a rear roof panel 20R.

A panel manufactured according to the method of manufacturing the lightweight panel for a vehicle according to the present disclosure is a lightweight panel that has continuous hexagonal pillar structures therein and includes a paper honeycomb P made of paper. As shown in FIGS. 3 and 4, the roof panel is mounted as a detachable roof panel in a vehicle, thereby allowing a user to easily handle the subpanels 20FL, 20FR, and 20R when attaching and detaching the subpanels 20FL, 20FR, and 20R.

The method of manufacturing a lightweight panel for a vehicle according to the present disclosure includes a mat fixing operation (S120) for manufacturing a first semi-finished product 20-1 by fixing a mat 22 to each of upper and lower surfaces of a paper honeycomb P having a predetermined thickness. Additionally, the method includes a resin spraying operation (S130) of manufacturing a second semi-finished product 20-2 by spraying a resin 24 onto each of upper and lower surfaces of the first semi-finished product 20-1 and includes a thermal molding operation (S150) of manufacturing a third semi-finished product 20-3 by thermally molding the second semi-finished product 20-2 between heated upper thermal mold 53 and lower thermal mold 51. The method also includes a sheet attaching operation (S160) of manufacturing a fourth semi-finished product 20-4 by attaching a sheet 23 molded on an upper surface of the third semi-finished product 20-3 and includes a trimming operation (S170) of cutting an unnecessary area of the fourth semi-finished product 20-4.

The sheet molding operation (S110) includes molding the sheet 23 to a predetermined shape by heating the sheet 23 while a perimeter of the sheet is fixed to a sheet fixing frame 32 and then moving a sheet mold 31 upward.

The sheet 23 is made of a composite material containing a synthetic resin. The sheet 23 may be supplied or provided with its perimeter or circumference fixed to the sheet fixing frame 32.

An upper surface of the sheet mold 31 is processed in a state in which the sheet 23 has been molded. When the sheet mold 31 moves toward a lower surface of the heated sheet 23, the sheet 23 is molded according to a shape of the upper surface of the sheet mold 31.

In particular, the sheet molding operation (S110) includes bringing the sheet 23 into contact with the sheet mold 31 through vacuum molding that withdraws or removes air between a lower surface of the sheet 23 and the sheet mold 31 when the upward movement of the sheet mold 31 is finished.

Therefore, the sheet 23 is molded to have a shape that matches or corresponds to the shape of the upper surface of the sheet mold 31.

Meanwhile, the sheet molding operation (S110) may be performed before the sheet attaching operation (S160), as the order is irrelevant. In other words, the sheet molding operation (S110) may be performed before the mat fixing operation (S120) or between the mat fixing operation (S120) and the sheet attaching operation (S160).

The mat fixing operation (S120) includes fixing each of the upper and lower surfaces of the paper honeycomb P processed to the predetermined thickness to become the first semi-finished product 20-1.

The paper honeycomb P is milled in advance, and when the panel is completed, becomes the honeycomb part 21 of the panel. The paper honeycomb P is milled to a predetermined thickness to become the honeycomb part 21. Since the thickness of the honeycomb part 21 of the panel varies depending on location, the thickness of the paper honeycomb P varies depending on location by reflecting the same. In addition, when the paper honeycomb P is milled to become the honeycomb part 21, the paper honeycomb P is machined to be larger than a target size of the honeycomb part 21. The honeycomb part 21 provided in the mat fixing operation (S120) is larger than the target size. As described below, the honeycomb part 21 is molded to the target size in the thermal molding operation (S150).

When the paper honeycomb P is milled into the honeycomb part 21, the paper honeycomb P needs to be face-milled. Thus, the paper honeycomb P is milled into the honeycomb part 21 using a face cutter, etc.

The honeycomb part 21 supports a load acting in a vertical direction of the panel by the hexagonal pillar structures formed therein.

The mat 22 may be a fiberglass mat 22 (e.g., glass fiber mat 22) made of glass fiber. When the manufacturing of the panel is completed, the fiberglass mat 22 is attached to the upper and lower surfaces of the honeycomb part 21 so that the honeycomb part 21 and the glass fiber mat 22 form a rigid layer of the panel. The sheet 23, which becomes a skin of the panel, is attached to the rigid layer to complete the panel.

The first semi-finished product 20-1 is formed by temporarily fixing the fiberglass mat 22 to the upper and lower surfaces of the paper honeycomb P using a gripper, etc. on the perimeter of the paper honeycomb P.

The resin spraying operation (S130) includes manufacturing the second semi-finished product 20-2 by spraying a resin onto the upper and lower surfaces of the first semi-finished product 20-1.

The resin spraying operation (S130) includes spraying the resin 24 from resin spray nozzles 41 disposed to face each other vertically while moving the first semi-finished product 20-1 between the resin spray nozzles 41 and applying the resin 24 onto each of the upper and lower surfaces of the first semi-finished product 20-1.

Alternatively, in a state in which the first semi-finished product 20-1 is fixed, the resin spray nozzle 41 may spray the resin 24 onto the upper and lower surfaces of the first semi-finished product 20-1 while moving between upper and lower portions of the first semi-finished product 20-1.

The resin 24 may be polyurethane. The second semi-finished product 20-2 is manufactured by applying the polyurethane to the first semi-finished product 20-1. The polyurethane is infused or impregnated into the mat 22 and the honeycomb part 21 so that the honeycomb part 21 is bonded to the mat 22, thereby increasing the rigidity of the mat 22 and the honeycomb part 21.

The seating operation S140 includes seating the second semi-finished product 20-2 on the lower thermal mold 51 to thermally mold the second semi-finished product 20-2.

Meanwhile, a guide plate 52 for guiding the seating of the second semi-finished product 20-2 is installed on the perimeter of the lower thermal mold 51. According to some examples, a plurality of guide plates 52 may be installed on the perimeter if the lower thermal mold 51 at an interval. The guide plate 52 has a lower portion fastened to a side surface of the lower thermal mold 51 and an upper portion formed with a guide portion 52a to support the side surface of the second semi-finished product 20-2. Since the guide plate 52 only needs to guide one of both ends of the second semi-finished product 20-2, the guide plate 52 may be installed to guide two of four perimetric surfaces of the second semi-finished product 20-2.

The second semi-finished product 20-2 is in a flat state, but since the lower thermal mold 51 is in a state of having a rounded upper surface according to the shape of the panel, the second semi-finished product 20-2 may be unstably seated on the lower thermal mold 51. However, when a side end of the second semi-finished product 20-2 is in contact with the guide plate 52, movement of the second semi-finished product 20-2 is restricted. Therefore, when the second semi-finished product 20-2 is seated on the lower thermal mold 51, the second semi-finished product 20-2 may be easily seated at the correct location, and in the seated state, the movement of the second semi-finished product 20-2 is restricted.

The thermal molding operation (S150) includes manufacturing the third semi-finished product 20-3 by thermally molding the second semi-finished product 20-2 between the heated upper thermal mold 53 and lower thermal mold 51.

In a state in which the second semi-finished product 20-2 is seated on the lower thermal mold 51, the upper thermal mold 53 is moved downward to the lower thermal mold 51 so that the second semi-finished product 20-2 becomes the third semi-finished product 20-3. The second semi-finished product 20-2 is in a flat state, and the honeycomb part 21 is in a state of being processed slightly larger than the target size. However, when the heated upper thermal mold 53 is moved downward to the heated lower thermal mold 51, the second semi-finished product 20-2 is molded to the predetermined shape and the target size together with the lower surface of the upper thermal mold 53 and the upper surface of the lower thermal mold 51.

The sheet attaching operation (S160) includes manufacturing the fourth semi-finished product 20-4 by attaching the molded sheet 23 to an upper surface of the third semi-finished product 20-3.

The third semi-finished product 20-3 is seated on the lower sheet attachment mold 61 and an adhesive is applied to the upper surface of the third semi-finished product 20-3. The adhesive bonds the molded sheet 23 to the third semi-finished product 20-3. Meanwhile, the third semi-finished product 20-3 may be applied with the adhesive before seated on the lower sheet attachment mold 61 and then may be seated on the lower sheet attachment mold 61 in a state of being applied with the adhesive.

When the adhesive is applied to the upper surface of the third semi-finished product 20-3, the sheet 23 molded in the sheet molding operation (S110) is attached to the upper surface of the third semi-finished product 20-3.

Thereafter, the fourth semi-finished product 20-4 is manufactured by moving the upper sheet attachment mold 62 downward to the lower sheet attachment mold 61 and bonding the sheet 23 becoming the skin of the panel to the third semi-finished product 20-3.

The sheet attaching operation (S160) may be performed in a state in which the lower sheet attachment mold 61 and the upper sheet attachment mold 62 are heated as predetermined temperature.

The trimming operation (S170) includes cutting an unnecessary area from the fourth semi-finished product 20-4.

The trimming operation (S170) includes cutting an unnecessary scrap from the perimeter of the fourth semi-finished product 20-4 using a water jet when the fourth semi-finished product 20-4 is seated on a jig. The unnecessary area of the perimeter of the fourth semi-finished product 20-4 is cut using a water jet nozzle 72 mounted on a robot arm 73. In other words, the fourth semi-finished product 20-4 becomes the panel by cutting the unnecessary scrap of the perimeter of the fourth semi-finished product 20-4 while the water jet nozzle 72 moves along the perimeter of the fourth semi-finished product 20-4.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. A method of manufacturing a lightweight panel for a vehicle, the method comprising:
fixing a mat to each of upper and lower surfaces of a paper honeycomb having a predetermined thickness during a mat fixing operation thereby manufacturing a first semi-finished product;
applying a resin onto each of upper and lower surfaces of the first semi-finished product during a resin spraying operation thereby manufacturing a second semi-finished product;
thermally molding the second semi-finished product between a heated upper thermal mold and a heated lower thermal mold during a thermal molding operation thereby manufacturing a third semi-finished product;
attaching a molded sheet to an upper surface of the third semi-finished product during a sheet attaching operation thereby manufacturing a fourth semi-finished product; and
cutting an unnecessary area from the fourth semi-finished product during a trimming operation.

2. The method of claim 1, wherein an inside of the paper honeycomb provided in the mat fixing operation is machined to a predetermined thickness through milling.

3. The method of claim 1, wherein the mat in the mat fixing operation is a fiberglass mat.

4. The method of claim 1, wherein the paper honeycomb provided in the mat fixing operation is provided in a state of being machined to be larger than a target size, and wherein the paper honeycomb is molded to the target size in the thermal molding operation.

5. The method of claim 1, wherein the resin spraying operation includes spraying the resin from resin spray nozzles disposed to vertically face each other while moving the first semi-finished product between the resin spray nozzles and applying the resin onto the upper and lower surfaces of the first semi-finished product.

6. The method of claim 1, wherein the resin spraying operation includes spraying polyurethane onto the upper and lower surfaces of the first semi-finished product.

7. The method of claim 1, further comprising seating the second semi-finished product on the lower thermal mold during a seating operation.

8. The method of claim 7, wherein a guide plate configured to guide the seating of the second semi-finished product is installed on a perimeter of the lower thermal mold.

9. The method of claim 8, wherein the seating operation includes bringing a side end of the second semi-finished product into contact with the guide plate when the second semi-finished product is seated.

10. The method of claim 1, wherein the sheet attaching operation includes bonding the sheet to an upper surface of the third semi-finished product by seating the third semi-finished product on the lower sheet attachment mold, applying an adhesive onto the upper surface of the seated third semi-finished product, attaching the molded sheet to the upper surface of the third semi-finished product, and moving an upper sheet attachment mold downward.

11. The method of claim 1, wherein the trimming operation includes trimming a perimeter of the fourth semi-finished product seated on a jig while a water jet nozzle moves along the perimeter of the fourth semi-finished product.

12. The method of claim 1, further comprising a sheet molding operation of molding a sheet forming a skin of a panel to a predetermined shape.

13. The method of claim 12, wherein the sheet molding operation includes molding the sheet to a shape of an upper surface of a sheet mold by heating the sheet having a perimeter fixed to a sheet fixing frame and moving the sheet mold upward.

14. The method of claim 13, wherein the sheet molding operation includes bringing the sheet into contact with the sheet mold by removing air between the sheet and the sheet mold when moving the sheet mold upward to the sheet is completed.

15. The method of claim 12, wherein the sheet molding operation is performed before the sheet attaching operation.
